(19) United States
(12) Patent Application Publication
(10) Pub. No.: US 2026/0154035 A1
(43) Pub. Date: Jun. 4, 2026

(54) Bias Correction Circuitry for Fixed-Point Multiterm Addition

(71) Applicant: Apple Inc., Cupertino, CA (US)

(72) Inventors: Evan R. Lissoos, Austin, TX (US); Anurag Choudhury, Austin, TX (US); Christopher A. Burns, Austin, TX (US); Jason D. Math, Austin, TX (US)

(21) Appl. No.: 18/962,682

(22) Filed: Nov. 27, 2024

Related U.S. Application Data
(60) Provisional application No. 63/700,142, filed on Sep. 27, 2024.

(51) Int. Cl. G06F 7/499; G06F 7/50; G06F 7/523

(52) U.S. Cl. CPC G06F 7/49915; G06F 7/50; G06F 7/523

(57) ABSTRACT

Bias correction circuitry and techniques for multiterm addition are disclosed. An embodiment of an apparatus includes alignment circuitry, fixed-point correction circuitry, fixed-point addition circuitry and conversion circuitry. The alignment circuitry is configured to generate a set of fixed-point addend terms using mantissa values of a set of floating-point addend terms. The correction circuitry is configured to determine one or more bias correction values corresponding to one or more addend terms of the set of fixed-point addend terms. The addition circuitry is configured to produce a fixed-point addition result using the set of fixed-point addend terms and the one or more bias correction values, and the conversion circuitry is configured to generate a floating-point addition result using the fixed-point addition result.

### CROSS-REFERENCE TO RELATED APPLICATIONS

This application claims priority to U.S. Provisional App. No. 63/700,142 entitled “Bias Correction Circuitry for Multiterm Addition,” filed Sep. 27, 2024, the disclosure of which is hereby incorporated by reference herein in its entirety.

### BACKGROUND

### Technical Field

This disclosure relates generally to computer processors and more particularly to floating-point addition circuitry.

### Description of Related Art

Modern computer systems often include processors that are integrated onto a chip with other computer components, such as memories or communication interfaces. During operation, the processors execute instructions to implement complex functions for various applications such as numeric computations, graphics processing, machine learning algorithms, display processing, and so forth. Some of these functions include addition of multiple operands; one example is dot product operations used in matrix multiplication. Operands in processors may be expressed in various number formats, including floating-point and fixed-point formats.

Various errors can arise from adding multiple terms together. In a fixed-point implementation having all of the terms aligned to the largest term, error can arise from truncation of a term by discarding bits that are shifted out during the alignment. Errors can be particularly significant when terms of opposite sign have higher-order bits that cancel one another, while lower-order bits have been discarded. The error from truncation may also be “biased” in the sense of preferentially under-approximating the result.

### BRIEF DESCRIPTION OF DRAWINGS

FIG. 1 is a block diagram illustrating example elements of a multiterm addition circuit including bias correction circuitry, according to some embodiments.

FIG. 2 is a block diagram illustrating an example pipeline, according to some embodiments.

FIG. 3 is a block diagram illustrating operation of example elements of dot product execution circuitry, according to some embodiments.

FIG. 4 is a block diagram illustrating an example bit position arrangement for an operand, according to some embodiments.

FIGS. 5A-5C are block diagrams illustrating example bias correction determination circuits, according to some embodiments.

FIG. 5D is a flow diagram illustrating an example method of bias correction determination, according to some embodiments.

FIG. 6 is a flow diagram illustrating an example method, according to some embodiments.

FIG. 7 is a block diagram illustrating example elements of a computing device, according to some embodiments.

FIG. 8 is a block diagram illustrating an example computing device that is usable in various types of systems, according to some embodiments.

FIG. 9 is a block diagram illustrating a computer-readable storage medium storing circuit design information for a computing device, according to some embodiments.

### DETAILED DESCRIPTION

As noted above, processor operations may involve multiterm addition. In some processor execution circuits, floating-point addends are converted to a fixed-point format for the addition, with the result converted back to floating point form. Such conversion may provide advantages in allowing integer and floating-point operations to share the same datapath, for example. The conversion from a floating-point format using an exponent to a fixed-point format often involves shifting smaller terms to align them with the largest term. For terms that are many orders of magnitude smaller than the largest term, many bits may be shifted out of the defined width of the fixed-point operand. These shifted-out bits are typically discarded, which can lead to errors in the addition and the processes using the addition (such as image processing or training of machine learning algorithms).

In disclosed embodiments, a bias correction circuit is configured to receive at least a portion of the bits shifted from terms during alignment and determine one or more bias correction values based on values of the shifted bits. In some embodiments the bias correction values are also based on values of the least significant bits of the aligned terms. In some embodiments, a bias correction value is generated for each shifted operand. The bias correction values may then be included in the multiterm addition operation. The present disclosure presents embodiments with various different approaches to determine bias correction terms.

The bias correction circuitry disclosed herein allows correction of individual addends to mitigate errors caused by alignment into fixed-point form. In various embodiments, this correction of individual addends may reduce the bias toward zero caused by truncation during alignment. Improved accuracy of addition results produced by the bias correction circuitry may allow a smaller operand bit width to be used for the addition circuit to obtain a given accuracy level. This reduction in bit width reduces chip area and power consumption of the execution circuitry by requiring, for example, less wiring and fewer adder elements within the adder circuitry.

### Overview of Bias Mitigation Using Correction Terms for Addition Circuitry

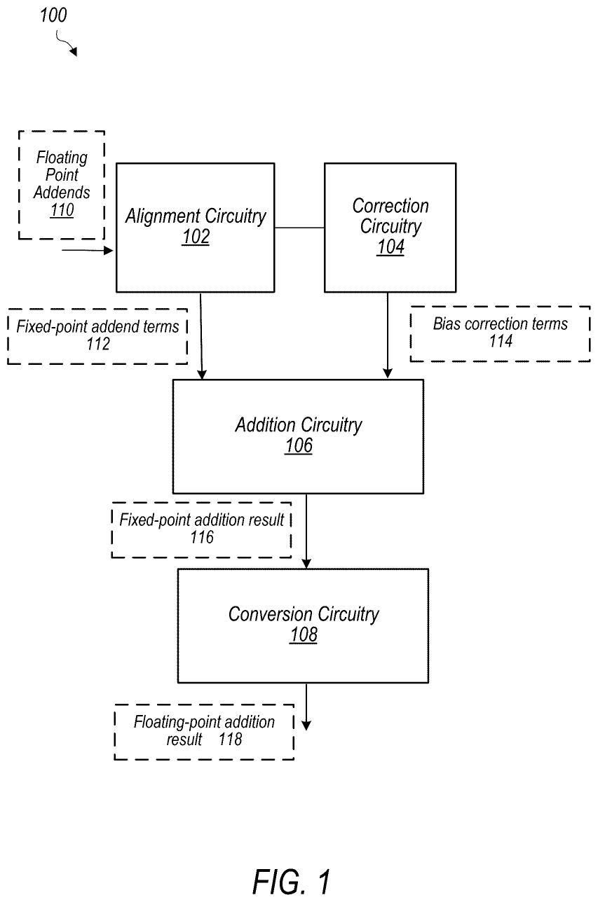

FIG. 1 is a block diagram illustrating example elements of a multiterm addition circuit including bias correction circuitry, according to some embodiments. In the illustrated example, execution circuitry 100 includes alignment circuitry 102, correction circuitry 104, addition circuitry 106, and conversion circuitry 108.

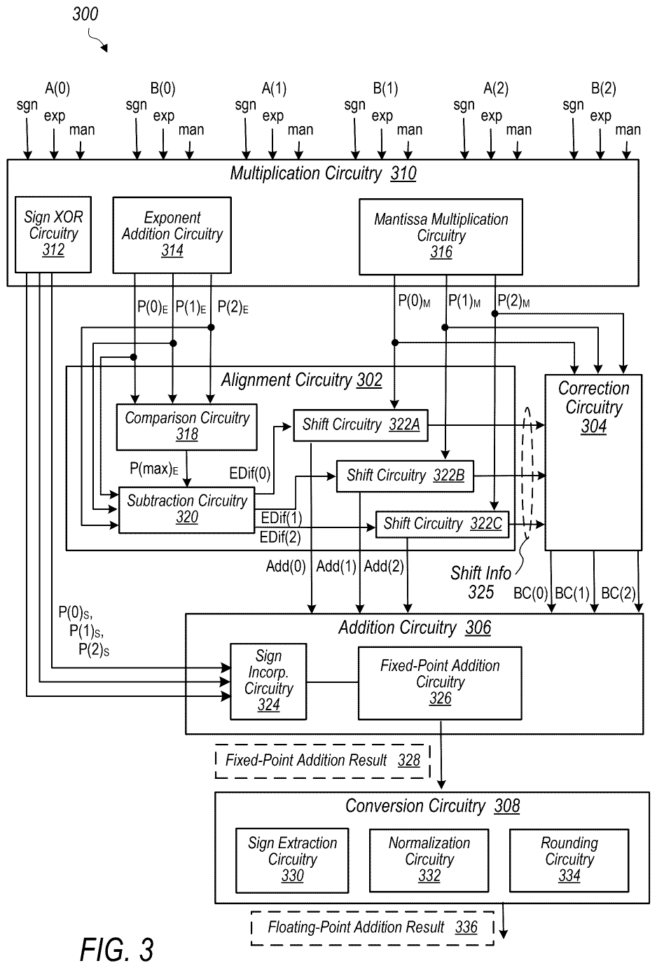

Alignment circuitry 102, in the illustrated example, is configured to receive floating-point addends 110 and align the addends to generate fixed-point addend terms 112. Alignment circuitry 102 also provides information about the alignment (e.g., bits shifted out and potentially other bits) to correction circuitry 104. Operation of alignment circuitry such as circuitry 102 is discussed further in connection with FIG. 3 below.

Correction circuitry 104, in the illustrated example, is configured to generate bias correction terms 114 corresponding to fixed-point addend terms 112. As shown, these correction terms may be additional terms input to addition circuitry and may mitigate or correct bias in the context of fixed-point conversion for addition operations. Use of correction circuitry 104 in conjunction with alignment circuitry 102 allows correction of individual addends, by contrast to techniques applying rounding or correction only to the addition result. Correction of the individual addends may reduce average error per operation and reduce a bias toward zero exhibited by addition circuitry that simply discards shifted-out bits during alignment.

Addition circuitry 106, in the illustrated example, is configured to add the fixed-point addend terms 112 and bias correction terms 114 to generate a fixed-point addition result 116. Addition circuitry 106 may implement one of various appropriate topologies, e.g., with different tradeoffs between performance, circuit area, and power consumption.

Conversion circuitry 108, in the illustrated example, is configured to convert the fixed-point addition result 116 back to a floating-point representation to generate a floating-point addition result 118.

### Example pipeline

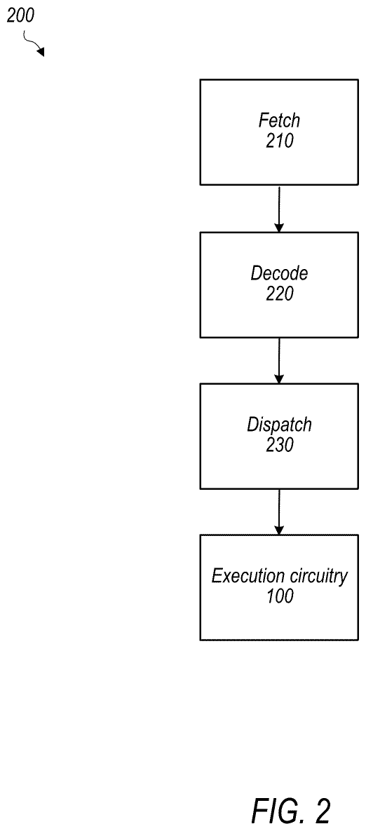

FIG. 2 is a block diagram illustrating an example pipeline, according to some embodiments. In the illustrated embodiment, the example pipeline illustrates multiple elements including fetch stage 210, decode stage 220, dispatch stage 230, and execution circuitry 100. While the illustrated stages are included for purposes of illustration, a given pipeline may include various other stages or may omit illustrated stages, in other embodiments. Further, one or more illustrated elements may themselves be pipelined (e.g., execution circuitry 100 may include multiple stages).

The concept of a processor “pipeline” is well understood, and refers to the concept of splitting the “work” a processor performs on instructions into multiple stages. In some embodiments, instruction decode, dispatch, execution (i.e., performance), and retirement may be examples of different pipeline stages. Many different pipeline architectures are possible with varying orderings of elements/portions. Various pipeline stages perform such steps on an instruction during one or more processor clock cycles, then pass the instruction or operations associated with the instruction on to other stages for further processing.

Fetch stage circuitry 210, in some embodiments, is configured to fetch instructions for execution, including instructions that specify to evaluate a floating-point power function. In some embodiments, a floating-point power instruction may be a single instruction-set-architecture (ISA) instruction. In some embodiments, disclosed operations that include adds may be a single micro-operation supported by the processor. In other embodiments, a given instruction may be implemented using multiple micro-operations.

Decode stage circuitry 220, in the illustrated embodiment, is configured to decode the fetched instruction from stage 210. In some embodiments, decode 220 prepares the fetched instruction for further processing such as by inspecting opcodes of the fetch instruction and determining locations of source and destination operands, for example.

Dispatch stage circuitry 230, in some embodiments, is configured to dispatch operations to reservation stations (not shown) within various execution units of pipeline circuitry, according to some embodiments.

In the illustrated embodiment, execution circuitry 100 is configured to perform one or more disclosed operations (e.g., add operations, dot product operations, etc.). Note that execution circuitry 100 may also include various other units, e.g., an integer unit, a load/store unit, etc. Various units of execution circuitry 100 may be pipelined. Execution circuitry 100 in various embodiments includes multiterm addition circuitry as disclosed herein.

### Detailed Example of Multiplication, Alignment, and Addition Circuitry

FIG. 3 is a block diagram illustrating operation of example elements of dot product execution circuitry, according to some embodiments. Dot product execution circuitry 300 includes multiplication circuitry combined with multiterm addition circuitry similar to circuitry 100 of FIG. 1. In the illustrated example, dot product execution circuitry 300 includes multiplication circuitry 310 (which in turn includes sign exclusive-or (XOR) circuitry 312, exponent addition circuitry 314, and mantissa multiplication circuitry 316), alignment circuitry 302 (which in turn includes comparison circuitry 318, subtraction circuitry 320, and shift circuitry 322A-322C), correction circuitry 304, addition circuitry 306 (which in turn includes sign incorporation circuitry 324 and fixed-point addition circuitry 326), and conversion circuitry 308 (which in turn includes sign extraction circuitry 330, normalization circuitry 332, and rounding circuitry 334).

Multiplication circuitry 310, in the illustrated embodiment, is configured to receive floating-point input operands for a dot product operation. Generally, a dot product operates on two equal-length sequences and returns a single value. In this example there are two input vectors A and B, each with three elements 0-2 (although similar techniques may be applied for various numbers of elements per vector). Therefore, in this example, multiplication circuitry 310 performs three floating-point multiplications to generate three products (P), which are to be added to generate the dot product result. Each vector element and product in this example is a floating-point number with a sign (sgn/S) exponent (exp/E) and mantissa (man/M).

Sign XOR circuitry 312 is configured to exclusive-or the sign bits for a given product of the three generated products to generate a sign for that product. Exponent addition circuitry 314 is configured to add the exponents of the inputs for each multiplication operation to generate the product exponents. Mantissa multiplication circuitry 316, in some embodiments, is configured to perform integer multiplication on the mantissa inputs for each of the three multiplication operations.

Alignment circuitry 302 is one example of circuitry 102 of FIG. 1 and is configured to perform shift operations to generate fixed-point inputs for addition circuitry 306. In particular, comparison circuitry 318 is configured to determine the greatest exponent among the three product exponents and provide the result to subtraction circuitry 320. Subtraction circuitry 320 is configured to generate exponent difference values EDif for each term, which are provided to respective shift circuitry 322A-322C. The exponent difference EDif indicates how many bits need to be shifted to align a given term to the term with the maximum exponent. Shift circuitry 322A-322C is configured to perform the indicated shift operations and provide the results as addends to addition circuitry 306, as well as provide shift information to correction circuitry 304. In an embodiment, shift information 325 includes the EDif values for each term.

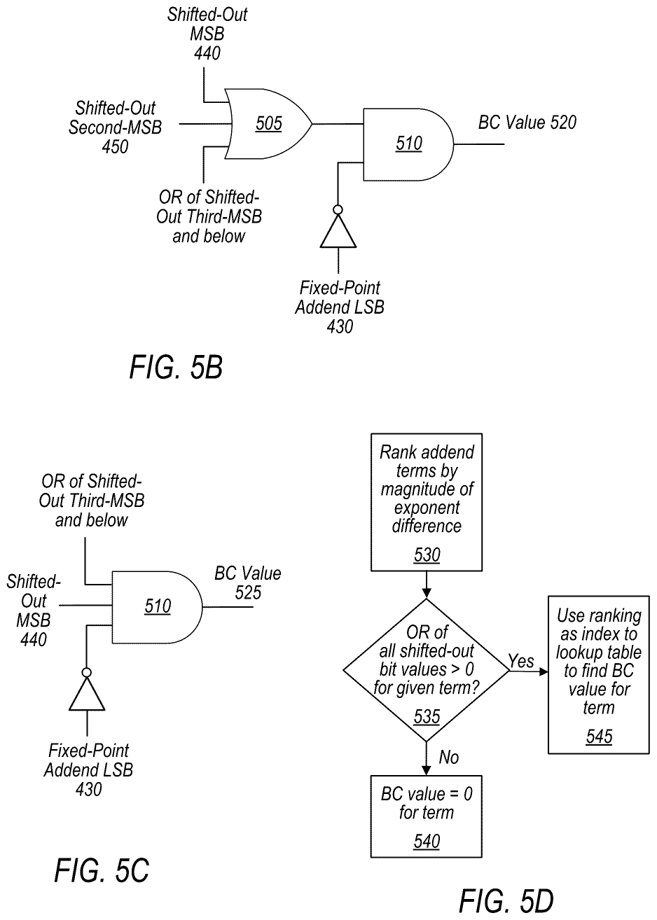

Correction circuitry 304 is configured to generate bias correction terms BC(0), BC(1), and BC(2) based on shift information from alignment circuitry 302. In an embodiment, correction circuitry 304 is configured to obtain the shifted-out bits for a given term using the mantissa P_{M} for the term and shift information 124 (such as how many bits were shifted) for that operand. In some embodiments, correction circuitry 304 uses a masking operation to obtain shifted-out bits used in generating bias correction terms BC(0), BC(1), and BC(2). Examples of bias correction term generation approaches based on the shifted-out bits, and in some cases bits of the fixed-point addends, are described further below in connection with FIGS. 5A-5D.

Addition circuitry 306 is one example of circuitry 106 of FIG. 1 and is configured to perform fixed-point addition of its fixed-point addends and the bias correction terms to generate a fixed-point addition result 328. In particular, sign incorporation circuitry 324 is configured to receive the signs for the products generated by multiplication circuitry 310 and apply the signs appropriately (e.g., inverting addends prior to addition if their signs are negative). In an embodiment, sign incorporation circuitry 324 expresses the fixed-point addends in a 2's complement format reflecting each addend's sign. Fixed-point addition circuitry 326 is configured to perform integer addition of the addends to generate the fixed-point addition result 328. In some embodiments, the bias correction terms are added to their corresponding addend terms prior to adding together of the addend terms. Such adding of the bias correction terms to their corresponding addend terms may be performed prior to or in conjunction with expressing the addends in a 2's complement format in some embodiments.

Conversion circuitry 308 is configured to convert the fixed-point addition result 328 from addition circuitry 306 to a floating-point representation to generate floating-point addition result 336. In particular, sign extraction circuitry 330 is configured to determine the sign of the result 328 (e.g., depending on its integer representation, such as 2's complement). Normalization circuitry 332 is configured to shift the addition result 328 as needed (e.g., based on the position of its leading set bit) and set the floating-point result exponent based on the amount of shifting. Rounding circuitry 334 is configured to round the result, if necessary, e.g., based on bits shifted out during normalization. Conversion circuitry 308 may also include control circuitry (not shown) configured to handle special values (e.g., positive/negative infinity, subnormal, NaN, etc.).

### Example Bias Correction Determination Circuits

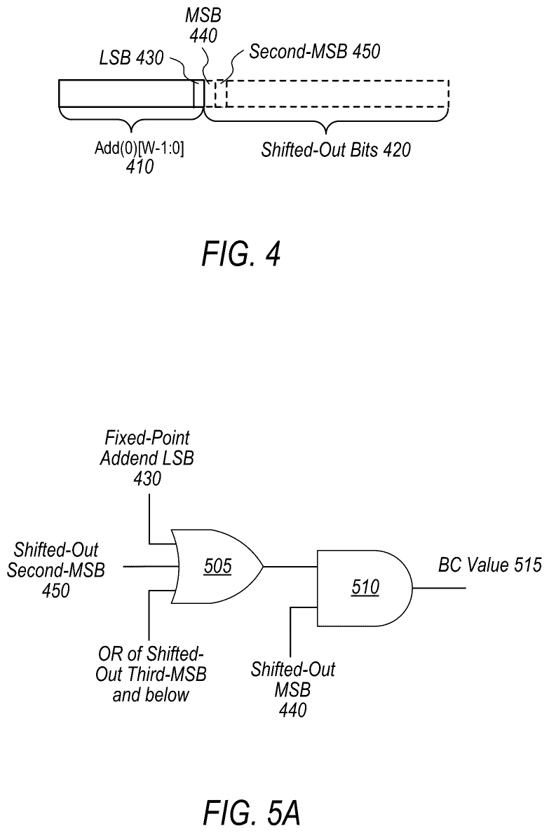

FIG. 4 is a block diagram illustrating an example bit position arrangement for an embodiment of a mantissa value P(0)_{M} after shifting by alignment circuitry such as circuitry 302 of FIG. 3. In the illustrated example, shift circuitry such as circuitry 322A has shifted the mantissa value such that W bits [W- 1:0] 410 remain to form, for example, fixed point addend Add(0) for an add operation and bits 420 are shifted out. As shown, bits 410 include a least-significant bit (LSB) 430.

Shifted-out bits 420 include a most-significant bit (MSB) 440 which is the last bit shifted out and a second-MSB 450 which is the second-to-last bit shifted out. Most-significant bit 440 of the shifted-out bits is sometimes referred to as a “guard” bit. Second-most significant bit 450 of the shifted-out bits is sometimes referred to as a “round” bit. In various embodiments, shift circuitry such as circuitry 322A, 322B or 322C may be sized to allow holding of one or more of shifted-out bits 420, which may be provided to correction circuitry 304 as part of shift information 325. The bit positions defined in FIG. 4 are referenced in the discussion of particular bias correction approaches given in connection with FIGS. 5A-5D below.

FIGS. 5A-5C are block diagrams illustrating example bias correction determination circuits included in correction circuitry such as circuitry 304, according to some embodiments. Note that various illustrated logic gates may be split into multiple gates or implemented using various different underlying circuitry to perform the indicated logical operations; these gates are included for purpose of illustration but not intended to limit the scope of the present disclosure.

In FIG. 5A, correction circuitry such as circuitry 304 includes OR gate 505 and AND gate 510. Gate 505 performs a logical OR operation on the fixed-point addend LSB 430, shifted-out second-MSB 450, and an OR operation of any additional shifted-out bits (i.e., the third-MSB and below). The OR of the additional shifted-out bits is sometimes referred to as a “sticky” bit: the OR result is set if any of these additional shifted-out bits are set. In an embodiment, such a sticky bit is determined by correction circuitry such as correction circuitry 304 using circuitry described by the following register-transfer level (RTL) code, where “prod” is an unshifted term similar to P_{M} in FIG. 3:

Assign {sticky_mask[21:0], sticky_mask_unused[OFFSET-1:0]} = ~ ({22′(′1), OFFSET′ (′1)}) <<
exp_diff;
Assign sticky = | (sticky_mask & prod);

The above code implements a mask to select bit positions contributing to the sticky bit and an OR-reduce operation OR-ing together the bit values of the selected bit positions. In other embodiments, the sticky bit may be calculated by other methods such as storing the shifted-out bits and then combining their values.

Gate 510 of FIG. 5A performs a logical AND operation on the output of gate 505 and the shifted-out MSB 440, and the output of gate 510 is provided as a bias correction value 515 (e.g., as an input to addition circuitry 306). As shown by the logic of FIG. 5A, if shifted-out MSB 440 is set and at least one of fixed-point addend LSB 430 or shifted-out second-MSB 450 or the OR of the remaining shifted-out bits is set for a given shifted term, then bias correction value 515 is “1”, otherwise the bias correction value for the term is zero.

In FIG. 5B, correction circuitry such as circuitry 304 includes OR gate 505 and AND gate 510. The gate arrangement of FIG. 5B is similar to that of FIG. 5A except that some of the input bit values are different. In this example, Gate 505 performs a logical OR operation on shifted-out MSB 440, shifted-out second-MSB 450 and the OR of the remaining shifted-out bits. Gate 510 performs a logical AND operation on the output of gate 505 and an inversion of the fixed-point addend LSB 430 to generate the bias correction value 520. As shown by the logic of FIG. 5B, in this approach the bias correction value for a given term is “1” if fixed-point addend LSB 430 is not set and if at least one of shifted-out MSB 440, shifted-out second-MSB 450 or the OR of the remaining shifted-out bits is set.

In the example of FIG. 5C, gate 510 performs a logical AND operation on the OR of the additional shifted-out bits (i.e., the third-MSB and below), the shifted-out MSB 440, and the inversion of the fixed-point addend LSB 430 to generate the bias correction value 525. For this approach, the bias correction value for a given term is “1” if fixed-point addend LSB 430 is not set and both the shifted-out MSB 440 and the OR of the additional shifted out bits are set.

FIG. 5D is a flow diagram illustrating another example method of determining bias correction values, according to some embodiments. In addition to considering bit values as in the circuits of FIGS. 5A-5C, the approach of 5D includes determining a ranking of the addend terms by the magnitude of the exponent difference between a given term and the maximum term.

At block 530, in the illustrated example, correction circuitry such as circuitry 304 ranks the addend terms by magnitude of exponent difference. An example of the exponent difference is the EDif exponent difference found for each term in alignment circuitry 302 of FIG. 3. The exponent difference is an indicator of the relative size of the addends, wherein a larger exponent difference from the maximum term indicates a smaller addend term. The exponent difference is also an indicator of the amount each addend is shifted during alignment and may be provided to correction circuitry such as correction circuitry 304 as shift information 325. In some embodiments, exponent difference Edif may be routed to correction circuitry 304 and shift circuitry 322 independently. In an embodiment, correction circuitry 304 includes a comparator-based circuit for ranking the addends by their respective exponent difference values.

At block 535, in the illustrated example, correction circuitry 304 determines, for a given term, if an OR of all shifted-out bit values is greater than 0. In this embodiment, the OR is “1” if any of the shifted-out bits 420 in FIG. 4 are set, including MSB 440, second-MSB 450, and the remaining shifted-out bits. This OR result may be viewed as a different type of “sticky” bit calculated using all of the shifted-out bits. If the result at 535 is “yes,” flow proceeds to 545. Otherwise, flow proceeds to 540.

At block 540, in the illustrated example, correction circuitry 304 sets the bias correction value to zero for the given term. If none of the shifted-out bits are set for a given term, no bias correction is provided. At block 545, correction circuitry 304 uses the ranking from block 530 as an index to a lookup table to find the bias correction value. For example, in some embodiments the lookup table may be configured to provide a “1” for the bias correction value if the term is ranked in the top half of the addend terms by relative size, and a zero value otherwise. Other thresholds may be used in other embodiments. Although not explicitly shown in FIG. 5D, the determination of blocks 535, 540 and 545 is carried out for each of the addend terms. The approach of FIG. 5D may in some embodiments provide improved accuracy by allowing the relative size of a term to be considered in determining a bias correction value. Such an advantage may be offset in some cases by the additional circuit area and power needed for circuitry such as comparison circuitry for ranking of the addend terms or storage circuitry for storing a lookup table.

It is noted that the bias correction value determination approaches of FIGS. 5A-5D are merely examples of how bias correction values for the individual addend terms may be determined. Combinations of these approaches or still different approaches may be used in various embodiments.

### Example Method

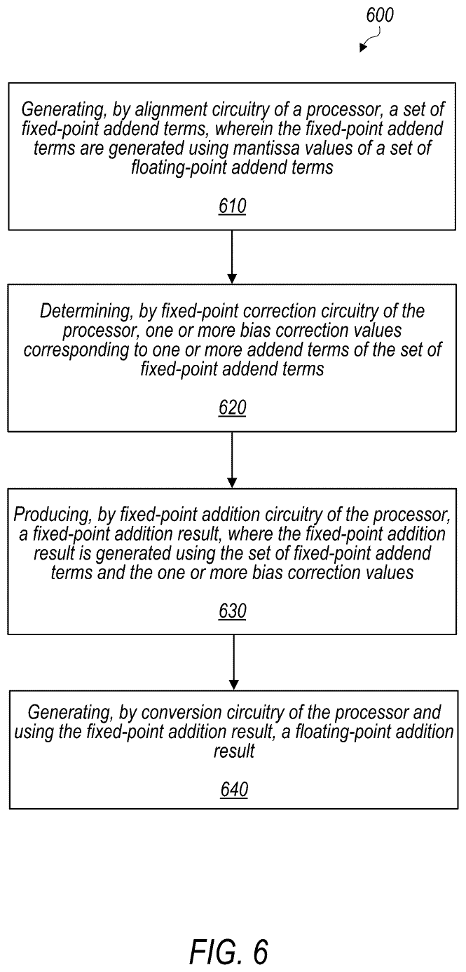

FIG. 6 is a flow diagram illustrating an example method, according to some embodiments. The method shown in FIG. 6 may be used in conjunction with any of the computer circuitry, systems, devices, elements, or components disclosed herein, among others. In various embodiments, some of the method elements shown may be performed concurrently, in a different order than shown, or may be omitted. Additional method elements may also be performed as desired.

At 610, in the illustrated embodiment, a computing system (e.g., alignment circuitry 302) generates a set of fixed-point addend terms, where the fixed-point addend terms are generated using mantissa values of a set of floating-point addend terms. Fixed-point addend terms 112 of FIG. 1 and addends Add(0), Add(1) and Add(2) of FIG. 3 are examples of such fixed-point addend terms. Floating point addends 110 of FIG. 1 are an example of floating-point addend terms and mantissa values P(0)_{M}, P(1)_{M} and P(2)_{M} of FIG. 3 are examples of mantissa values of floating-point addend terms. In an embodiment, generating the set of fixed-point addend terms includes determining a maximum floating-point addend term from among the set of floating-point addend terms. In a further embodiment, generating the set of fixed-point addend terms includes shifting mantissa values of floating-point addend terms other than the maximum floating-point addend term. Determining a maximum floating-point addend term includes finding the term with the maximum floating-point exponent value in some embodiments.

At 620, in the illustrated embodiment, the computing system (e.g., correction circuitry 304) determines one or more bias correction values corresponding to one or more addend terms of the set of fixed-point addend terms. Bias correction terms 114 of FIG. 1 and bias correction values BC(0), BC(1) and BC(2) of FIG. 3 are examples of bias correction values. In an embodiment, determining the one or more bias correction values includes determining bias correction values corresponding to fixed-point addend terms other than a maximum fixed-point addend term corresponding to a maximum floating-point addend term of the floating-point addend terms. In some embodiments, determining a bias correction value corresponding to a given fixed-point addend term includes using one or more bit values shifted out of the given fixed-point addend term when generating the set of fixed-point addend terms. In a further embodiment, determining the corresponding bias correction value for the given fixed-point addend term includes using a least significant bit value of the given fixed-point addend term. In some embodiments, determining a corresponding bias correction value for a given fixed-point addend term includes using a lookup table. Such a lookup table may include bias correction values based on relative size rankings of the fixed-point addend terms in some embodiments, as described in connection with FIG. 5D.

Determining the one or more bias correction values may in various embodiments include operations such as those shown in FIGS. 5A through 5D above. For example, in one embodiment determining the bias correction values may include determining a rank for each fixed-point addend term based on a number of bits the mantissa value of the corresponding floating-point term for each fixed-point addend term was shifted by alignment circuitry in generating the set of fixed-point addend terms. Such an embodiment may further include, for each of the fixed-point addend terms, determining whether any of the bits shifted out of the mantissa value of the corresponding floating point term have a value greater than zero, using a rank of the fixed-point addend term as an index to a lookup table to determine a bias correction value if any of the shifted-out bits has a value greater than zero, and setting the bias correction value to zero if none of the shifted-out bits has a value greater than zero.

At 630, in the illustrated embodiment, the computing system (e.g., addition circuitry 306) produces a fixed-point addition result, where the fixed-point addition result is generated using the set of fixed-point addend terms and the one or more bias correction values. Fixed-point addition results 116 of FIGS. 1 and 328 of FIG. 3 are examples of fixed-point addition results.

At 640, in the illustrated embodiment, the computing system (e.g., conversion circuitry 308) generates, using the fixed-point addition result, a floating-point addition result. Floating-point addition results 118 of FIGS. 1 and 336 of FIG. 3 are example of floating-point addition results. In an embodiment, method 600 also includes multiplying, by the computing system (e.g. multiplication circuitry 310 of FIG. 3), two floating-point multiplicand terms to produce a given floating-point addend term of the set of floating-point addend terms.

### Example Device

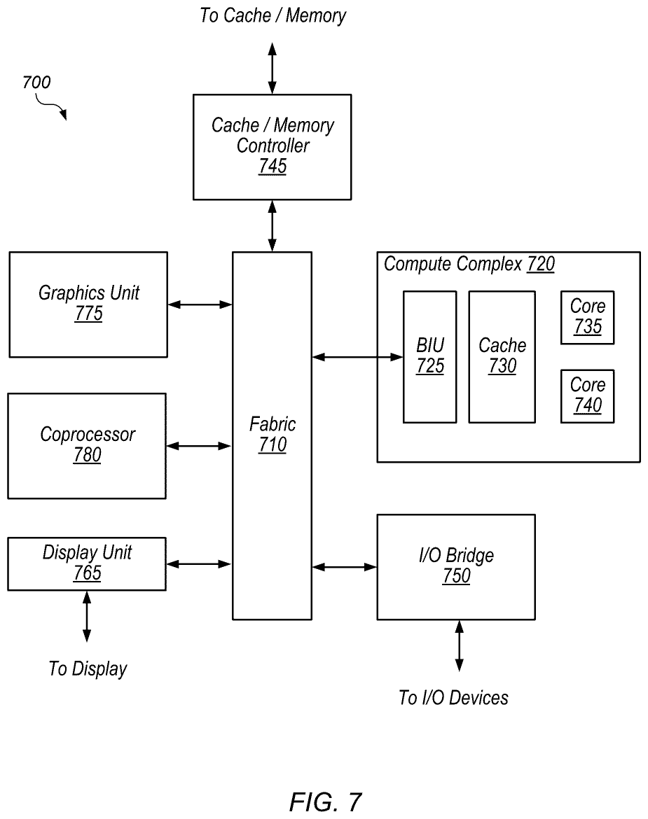

Referring now to FIG. 7, a block diagram illustrating an example embodiment of a device 700 is shown. In some embodiments, elements of device 700 may be included within a system on a chip. In some embodiments, device 700 may be included in a mobile device, which may be battery-powered. Therefore, power consumption by device 700 may be an important design consideration. In the illustrated embodiment, device 700 includes fabric 710, compute complex 720 input/output (I/O) bridge 750, cache/memory controller 745, graphics unit 775, and display unit 765. In some embodiments, device 700 may include other components (not shown) in addition to or in place of the illustrated components, such as video processor encoders and decoders, image processing or recognition elements, computer vision elements, etc.

Fabric 710 may include various interconnects, buses, MUX's, controllers, etc., and may be configured to facilitate communication between various elements of device 700. In some embodiments, portions of fabric 710 may be configured to implement various different communication protocols. In other embodiments, fabric 710 may implement a single communication protocol and elements coupled to fabric 710 may convert from the single communication protocol to other communication protocols internally.

In the illustrated embodiment, compute complex 720 includes bus interface unit (BIU) 725, cache 730, and cores 735 and 740. In various embodiments, compute complex 720 may include various numbers of processors, processor cores and caches. For example, compute complex 720 may include 1, 2, or 4 processor cores, or any other suitable number. In one embodiment, cache 730 is a set associative L2 cache. In some embodiments, cores 735 and 740 may include internal instruction and data caches. In some embodiments, a coherency unit (not shown) in fabric 710, cache 730, or elsewhere in device 700 may be configured to maintain coherency between various caches of device 700. BIU 725 may be configured to manage communication between compute complex 720 and other elements of device 700. Processor cores such as cores 735 and 740 may be configured to execute instructions of a particular instruction set architecture (ISA) which may include operating system instructions and user application instructions. These instructions may be stored in computer readable medium such as a memory coupled to memory controller 745 discussed below.

As used herein, the term “coupled to” may indicate one or more connections between elements, and a coupling may include intervening elements. For example, in FIG. 7, graphics unit 775 may be described as “coupled to” a memory through fabric 710 and cache/memory controller 745. In contrast, in the illustrated embodiment of FIG. 7, graphics unit 775 is “directly coupled” to fabric 710 because there are no intervening elements.

Cache/memory controller 745 may be configured to manage transfer of data between fabric 710 and one or more caches and memories. For example, cache/memory controller 745 may be coupled to an L3 cache, which may in turn be coupled to a system memory. In other embodiments, cache/memory controller 745 may be directly coupled to a memory. In some embodiments, cache/memory controller 745 may include one or more internal caches. Memory coupled to controller 745 may be any type of volatile memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to controller 745 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions executable by compute complex 720 to cause the computing device to perform functionality described herein.

Graphics unit 775 may include one or more processors, e.g., one or more graphics processing units (GPUs). Graphics unit 775 may receive graphics-oriented instructions, such as OPENGL®, Metal®, or DIRECT3D® instructions, for example. Graphics unit 775 may execute specialized GPU instructions or perform other operations based on the received graphics-oriented instructions. Graphics unit 775 may generally be configured to process large blocks of data in parallel and may build images in a frame buffer for output to a display, which may be included in the device or may be a separate device. Graphics unit 775 may include transform, lighting, triangle, and rendering engines in one or more graphics processing pipelines. Graphics unit 775 may output pixel information for display images. Graphics unit 775, in various embodiments, may include programmable shader circuitry which may include highly parallel execution cores configured to execute graphics programs, which may include pixel tasks, vertex tasks, and compute tasks (which may or may not be graphics-related).

Display unit 765 may be configured to read data from a frame buffer and provide a stream of pixel values for display. Display unit 765 may be configured as a display pipeline in some embodiments. Additionally, display unit 765 may be configured to blend multiple frames to produce an output frame. Further, display unit 765 may include one or more interfaces (e.g., MIPI® or embedded display port (eDP)) for coupling to a user display (e.g., a touchscreen or an external display).

I/O bridge 750 may include various elements configured to implement: universal serial bus (USB) communications, security, audio, and low-power always-on functionality, for example. I/O bridge 750 may also include interfaces such as pulse-width modulation (PWM), general-purpose input/output (GPIO), serial peripheral interface (SPI), and inter-integrated circuit (I2C), for example. Various types of peripherals and devices may be coupled to device 700 via I/O bridge 750.

In some embodiments, device 700 includes network interface circuitry (not explicitly shown), which may be connected to fabric 710 or I/O bridge 750. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 700 with connectivity to various types of other devices and networks.

### Example Applications

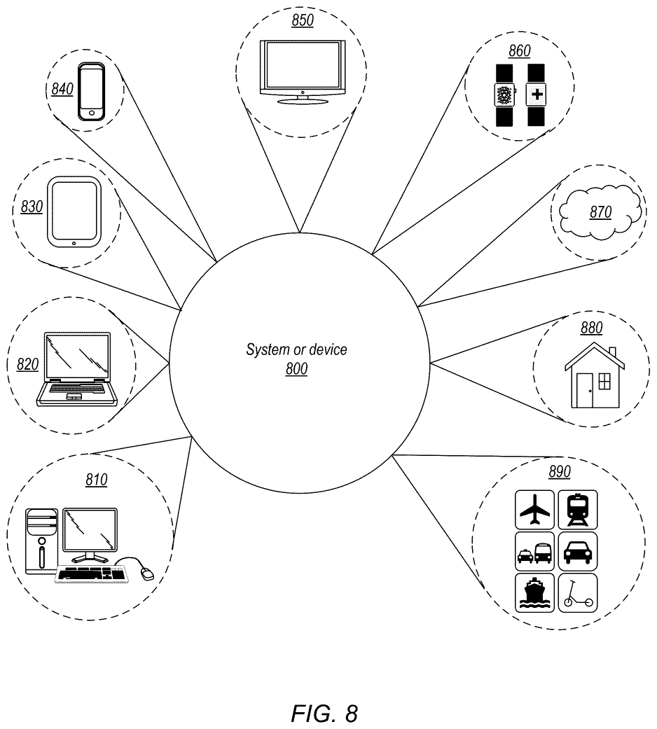

Turning now to FIG. 8, various types of systems that may include any of the circuits, devices, or system discussed above. System or device 800, which may incorporate or otherwise utilize one or more of the techniques described herein, may be utilized in a wide range of areas. For example, system or device 800 may be utilized as part of the hardware of systems such as a desktop computer 810, laptop computer 820, tablet computer 830, cellular or mobile phone 840, or television 850 (or set-top box coupled to a television).

Similarly, disclosed elements may be utilized in a wearable device 860, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 800 may also be used in various other contexts. For example, system or device 800 may be utilized in the context of a server computer system, such as a dedicated server or on shared hardware that implements a cloud-based service 870. Still further, system or device 800 may be implemented in a wide range of specialized everyday devices, including devices 880 commonly found in the home such as refrigerators, thermostats, security cameras, etc. The interconnection of such devices is often referred to as the “Internet of Things” (IoT). Elements may also be implemented in various modes of transportation. For example, system or device 800 could be employed in the control systems, guidance systems, entertainment systems, etc. of various types of vehicles 890.

The applications illustrated in FIG. 8 are merely exemplary and are not intended to limit the potential future applications of disclosed systems or devices. Other example applications include, without limitation: portable gaming devices, music players, data storage devices, unmanned aerial vehicles, etc.

### Example Computer-Readable Medium

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that programs a computing system to generate a simulation model of the hardware circuit, programs a fabrication system configured to produce hardware (e.g., an integrated circuit) that includes the disclosed circuitry, etc. Claims to such a storage medium are intended to cover, for example, an entity that produces a circuit design, but does not itself perform complete operations such as: design simulation, design synthesis, circuit fabrication, etc.

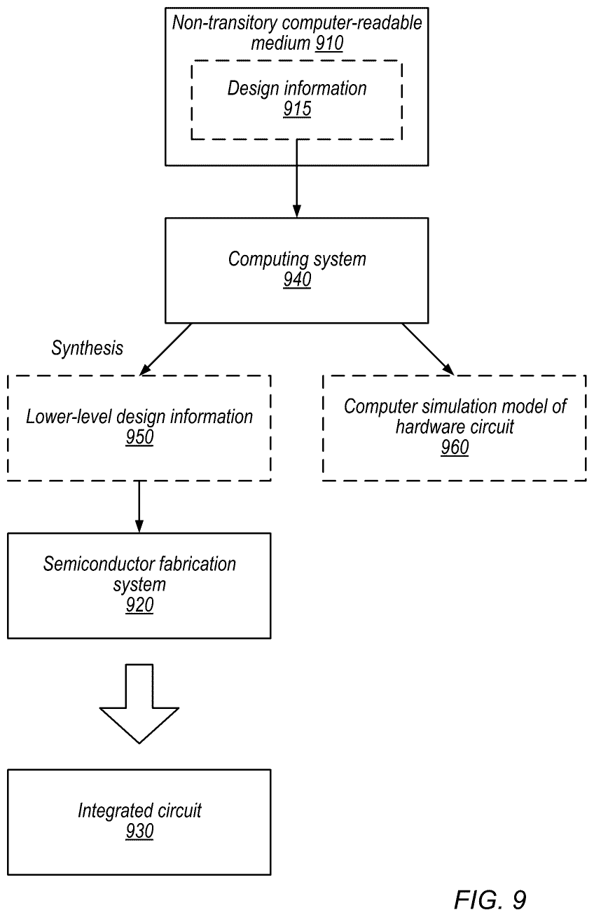

FIG. 9 is a block diagram illustrating an example non-transitory computer-readable storage medium that stores circuit design information, according to some embodiments. In the illustrated embodiment, computing system 940 is configured to process the design information. This may include executing instructions included in the design information, interpreting instructions included in the design information, compiling, transforming, or otherwise updating the design information, etc. Therefore, the design information controls computing system 940 (e.g., by programming computing system 940) to perform various operations discussed below, in some embodiments.

In the illustrated example, computing system 940 processes the design information to generate both a computer simulation model of a hardware circuit 960 and lower-level design information 950. In other embodiments, computing system 940 may generate only one of these outputs, may generate other outputs based on the design information, or both. Regarding the computing simulation, computing system 940 may execute instructions of a hardware description language that includes register transfer level (RTL) code, behavioral code, structural code, or some combination thereof. The simulation model may perform the functionality specified by the design information, facilitate verification of the functional correctness of the hardware design, generate power consumption estimates, generate timing estimates, etc.

In the illustrated example, computing system 940 also processes the design information to generate lower-level design information 950 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on lower-level design information 950 (potentially among other inputs), semiconductor fabrication system 920 is configured to fabricate an integrated circuit 930 (which may correspond to functionality of the simulation model 960). Note that computing system 940 may generate different simulation models based on design information at various levels of description, including information 950, 915, and so on. The data representing design information 950 and model 960 may be stored on medium 910 or on one or more other media.

In some embodiments, the lower-level design information 950 controls (e.g., programs) the semiconductor fabrication system 920 to fabricate the integrated circuit 930. Thus, when processed by the fabrication system, the design information may program the fabrication system to fabricate a circuit that includes various circuitry disclosed herein.

Non-transitory computer-readable storage medium 910, may comprise any of various appropriate types of memory devices or storage devices. Non-transitory computer-readable storage medium 910 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. Non-transitory computer-readable storage medium 910 may include other types of non-transitory memory as well or combinations thereof. Accordingly, non-transitory computer-readable storage medium 910 may include two or more memory media; such media may reside in different locations—for example, in different computer systems that are connected over a network.

Design information 915 may be specified using any of various appropriate computer languages, including hardware description languages such as, without limitation: VHDL, Verilog, SystemC, SystemVerilog, RHDL, M, MyHDL, etc. The format of various design information may be recognized by one or more applications executed by computing system 940, semiconductor fabrication system 920, or both. In some embodiments, design information may also include one or more cell libraries that specify the synthesis, layout, or both of integrated circuit 930. In some embodiments, the design information is specified in whole or in part in the form of a netlist that specifies cell library elements and their connectivity. Design information discussed herein, taken alone, may or may not include sufficient information for fabrication of a corresponding integrated circuit. For example, design information may specify the circuit elements to be fabricated but not their physical layout. In this case, design information may be combined with layout information to actually fabricate the specified circuitry.

Integrated circuit 930 may, in various embodiments, include one or more custom macrocells, such as memories, analog or mixed-signal circuits, and the like. In such cases, design information may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 920 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 920 may also be configured to perform various testing of fabricated circuits for correct operation.

In various embodiments, integrated circuit 930 and model 960 are configured to operate according to a circuit design specified by design information 915, which may include performing any of the functionality described herein. For example, integrated circuit 930 may include any of various elements shown in FIGS. 1-3, 5A-5C and 7. Further, integrated circuit 930 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model” does not imply that the instructions must be executed in order for the element to be met, but rather specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. As one example, different designs may select or connect gates based on design tradeoffs (e.g., to focus on power consumption, performance, circuit area, etc.). Further, different manufacturers may have proprietary libraries, gate designs, physical gate implementations, etc. Different entities may also use different tools to process design information at various layers (e.g., from behavioral specifications to physical layout of gates).

Once a digital logic design is specified, however, those skilled in the art need not perform substantial experimentation or research to determine those implementations. Rather, those of skill in the art understand procedures to reliably and predictably produce one or more circuit implementations that provide the function described by the design information. The different circuit implementations may affect the performance, area, power consumption, etc. of a given design (potentially with tradeoffs between different design goals), but the logical function does not vary among the different circuit implementations of the same circuit design.

In some embodiments, the instructions included in the design information instructions provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information. The lower-level design information may program fabrication system 920 to fabricate integrated circuit 930.

The various techniques described herein may be performed by one or more computer programs. The term “program” is to be construed broadly to cover a sequence of instructions in a programming language that a computing device can execute. These programs may be written in any suitable computer language, including lower-level languages such as assembly and higher-level languages such as Python. The program may be written in a compiled language such as C or C++, or an interpreted language such as JavaScript.

Program instructions may be stored on a “computer-readable storage medium” or a “computer-readable medium” in order to facilitate execution of the program instructions by a computer system. Generally speaking, these phrases include any tangible or non-transitory storage or memory medium. The terms “tangible” and “non-transitory” are intended to exclude propagating electromagnetic signals, but not to otherwise limit the type of storage medium. Accordingly, the phrases “computer-readable storage medium” or a “computer-readable medium” are intended to cover types of storage devices that do not necessarily store information permanently (e.g., random access memory (RAM)). The term “non-transitory,” accordingly, is a limitation on the nature of the medium itself (i.e., the medium cannot be a signal) as opposed to a limitation on data storage persistency of the medium (e.g., RAM vs. ROM).

The phrases “computer-readable storage medium” and “computer-readable medium” are intended to refer to both a storage medium within a computer system as well as a removable medium such as a CD-ROM, memory stick, or portable hard drive. The phrases cover any type of volatile memory within a computer system including DRAM, DDR RAM, SRAM, EDO RAM, Rambus RAM, etc., as well as non-volatile memory such as magnetic media, e.g., a hard drive, or optical storage. The phrases are explicitly intended to cover the memory of a server that facilitates downloading of program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems in which the programs are executed, as well as in a second set of one or more computer systems which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

The present disclosure includes references to “an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement of such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed is:

1. An apparatus, comprising:
alignment circuitry configured to generate a set of fixed-point addend terms using mantissa values of a set of floating-point addend terms;
fixed-point correction circuitry configured to determine one or more bias correction values corresponding to one or more addend terms of the set of fixed-point addend terms;
fixed-point addition circuitry configured to produce a fixed-point addition result using the set of fixed-point addend terms and the one or more bias correction values; and
conversion circuitry configured to generate a floating-point addition result using the fixed-point addition result.

2. The apparatus of claim 1, further comprising multiplication circuitry configured to multiply two floating-point multiplicand terms to produce a given floating-point addend term of the set of floating point addend terms.

3. The apparatus of claim 1, wherein:
the alignment circuitry is further configured to determine a maximum floating-point addend term from among the set of floating-point addend terms in generating the set of fixed-point addend terms; and
the fixed-point correction circuitry is configured to determine bias correction values corresponding to fixed-point addend terms other than a maximum fixed-point addend term corresponding to the maximum floating-point addend term.

4. The apparatus of claim 3, wherein:
the alignment circuitry is further configured to shift mantissa values of floating-point addend terms other than the maximum floating-point addend term in generating the set of fixed-point addend terms; and
the fixed-point correction circuitry is configured to use one or more bit values shifted out of a given fixed-point addend term in determining a corresponding bias correction value for the given fixed-point addend term.

5. The apparatus of claim 4, wherein the fixed-point correction circuitry is further configured to use a least significant bit value of the given fixed-point addend term in determining the corresponding bias correction value for the given fixed-point addend term.

6. The apparatus of claim 4, wherein the fixed-point correction circuitry is further configured to use a lookup table in determining the corresponding bias correction value for the given fixed-point addend term.

7. The apparatus of claim 1, further comprising processor control circuitry configured to forward the floating-point addition result as an instruction result for execution of a processor instruction for adding the set of floating-point addend terms.

8. The apparatus of claim 2, further comprising processor control circuitry configured to forward the floating-point addition result as an instruction result for execution of a processor instruction for finding a dot product of vectors including the floating-point multiplicand terms.

9. A method, comprising:
generating, by alignment circuitry of a processor, a set of fixed-point addend terms, wherein the fixed-point addend terms are generated using mantissa values of a set of floating-point addend terms;
determining, by fixed-point correction circuitry of the processor, one or more bias correction values corresponding to one or more addend terms of the set of fixed-point addend terms;
producing, by fixed-point addition circuitry of the processor, a fixed-point addition result, wherein the fixed-point addition result is generated using the set of fixed-point addend terms and the one or more bias correction values; and
generating, by conversion circuitry of the processor and using the fixed-point addition result, a floating-point addition result.

10. The method of claim 9, further comprising:
multiplying, by multiplication circuitry of the processor, two floating-point multiplicand terms to produce a given floating-point addend term of the set of floating-point addend terms.

11. The method of claim 9, wherein:
generating the set of fixed-point addend terms includes determining a maximum floating-point addend term from among the set of floating-point addend terms; and
determining the one or more bias correction values includes determining bias correction values corresponding to fixed-point addend terms other than a maximum fixed-point addend term corresponding to the maximum floating-point addend term.

12. The method of claim 11, wherein:
generating the set of fixed-point addend terms further includes shifting mantissa values of floating-point addend terms other than the maximum floating-point addend term; and
determining the one or more bias correction values includes using one or more bit values shifted out of a given fixed-point addend term to determine a corresponding bias correction value for the given fixed-point addend term.

13. The method of claim 12, wherein determining the corresponding bias correction value for the given fixed-point addend term includes using a least significant bit value of the given fixed-point addend term.

14. The method of claim 12, wherein determining the corresponding bias correction value for the given fixed-point addend term includes using a lookup table.

15. A non-transitory computer readable medium having stored thereon design information that specifies, in a format recognized by a fabrication system that is configured to use the design information to produce a hardware integrated circuit, at least a portion of a design of an execution circuit, the execution circuit comprising:
alignment circuitry configured to generate a set of fixed-point addend terms using mantissa values of a set of floating-point addend terms;
fixed-point correction circuitry configured to determine one or more bias correction values corresponding to one or more addend terms of the set of fixed-point addend terms;
fixed-point addition circuitry configured to produce a fixed-point addition result using the set of fixed-point addend terms and the one or more bias correction values; and
conversion circuitry configured to generate a floating-point addition result using the fixed-point addition result.

16. The computer readable medium of claim 15, wherein the execution circuit further comprises multiplication circuitry configured to multiply two floating-point multiplicand terms to produce each of the floating-point addend terms in the set of floating point addend terms.

17. The computer readable medium of claim 15, wherein the design information further specifies at least a portion of a design of a processor incorporating the execution circuit.

18. The computer readable medium of claim 17, wherein the processor is a graphics processor.

19. The computer readable medium of claim 15, wherein:
the alignment circuitry is further configured to determine a maximum floating-point addend term from among the set of floating-point addend terms in generating the set of fixed-point addend terms; and
the fixed-point correction circuitry is configured to determine bias correction values corresponding to fixed-point addend terms other than a maximum fixed-point addend term corresponding to the maximum floating-point addend term.

20. The computer readable medium of claim 19, wherein:
the alignment circuitry is further configured to shift mantissa values of the floating-point addend terms other than the maximum floating-point addend term in generating the set of fixed-point addend terms; and
the fixed-point correction circuitry is configured to use one or more bit values shifted out of a given fixed-point addend term in determining a corresponding bias correction value for the given fixed-point addend term.
